(19) United States
(12) Patent Application Publication
(10) Pub. No.: US 2005/0241243 A1
(43) Pub. Date: Nov. 3, 2005

(54) Modular assembly of resin components

(75) Inventors: Dave Wright, Ridgeway (CA); Tony Curatolo, Vaughan (CA)

Correspondence Address: C/O DENNISON ASSOCIATES, SUITE 301, 133 RICHMOND ST. WEST, TORONTO, ON, M5H 2L7, CA

(73) Assignee: ROYAL GROUP TECHNOLOGIES AND OUTBACK ESSENTIALS DIV. OF 876864 ONTARIO INC.

(21) Appl. No.: 10/829,194

(22) Filed: Apr. 22, 2004

(51) Int. Cl. E04H 1/00; E04H 3/00; E04H 5/00; E04H 6/00; E04H 9/00; E04H 14/00; E04C 1/00; B44F 7/00; B44F 9/00; E04F 13/08; E04B 1/00; E04G 21/00; E04G 23/00

(52) U.S. Cl. 52/79.9; 52/79.1; 52/741.13

(57) ABSTRACT

An assembly of modular resin components includes separate base plates for the components. The base plates secure to the components and connect them to one another in the assembly.

### FIELD OF THE INVENTION

The present invention relates to a modular assembly made of resin components which are connected to one another in the assembly.

### BACKGROUND OF THE INVENTION

As anyone who has made an outdoor patio will appreciate, the conventional large stones used in forming this type of patio are very heavy and are awkward to carry. These stones, which will typically have a size of about three feet by three feet, may often weigh a hundred pounds or more. They can be very difficult to interfit in an aligned manner with the adjacent stones used in forming the overall patio. Even when they are properly aligned during the initial formation of the patio they can often sink or separate relative to one another over time. Most outdoor patios made from conventional large patio stone end up with a very uneven surface.

As a further drawback, the stone material used in building the conventional outdoor patio can chip or crack particularly in cold weather climates necessitating ongoing maintenance of the overall patio structure.

There are many other modular constructions currently made of materials such as wood, stone etc. Most of these modular constructions which can include different types of wall or floor tiles require some type of forming for guiding and securing the inter-fitting of the modular components with one another. Furthermore, like the stone patio described above, they usually require substantial maintenance to keep them up to date.

### SUMMARY OF THE PRESENT INVENTION

The present invention provides an assembly of modular resin components. At least one of the components has a construction which includes a top wall with a projection downwardly from the top wall. The component further includes a base plate which secures to the projection and which provides a bottom support for the component.

In a specific aspect of the invention a number of the components include the construction as described above and the base plate connects side by side ones of the components together in the assembly.

With the components having the resin construction as described above, they do not need to be solid and as such are relatively light in weight. This also controls the cost of the components. As a further benefit the side by side components in the assembly share a common connection piece i.e., the base plate between the components which provides a very positive and strong interconnection of the components within the assembly.

By way of example, in a specific embodiment of the invention the component comprises a replica stone member.

The replica stone member has a top wall with a downwardly extending sidewall which surrounds a substantially hollow region covered by the top wall of the replica stone member. This makes the replica stone member on its own extremely light in weight and very easy to maneuver.

The base plate which attaches to the replica stone member beneath the top wall provides a ground seating surface for the assembly. In a preferred aspect of the invention the base plate further projects past the sidewall of the replica stone member and acts a connector for connecting adjacent replica stone members together with one another in forming an overall patio surface. The base plate may also act as connector for connecting edge trim to the patio surface.

### BRIEF DESCRIPTION OF THE DRAWINGS

The above as well as other advantages and features of the present invention will be described in greater detail according to the preferred embodiments of the present invention in which;

FIG. 1 is perspective view looking down on a ground structure formed by resin made replica patio stones in accordance with a preferred embodiment of the present invention;

FIG. 2 is a perspective view looking down on the undersurface of one of the replica stone members of the ground structure of FIG. 1;

FIG. 3 is an exploded perspective view of a region of the undersurface of the structure of FIG. 2;

FIG. 4 is an exploded perspective view of a different region of the undersurface of the structure of FIG. 2;

FIG. 4a is a perspective view of the top surface of the base plate from FIG. 4;

FIG. 5 is a perspective view looking down on a base plate from the structure of FIG. 1;

FIG. 6 is a sectional view along the lines 6-6 of FIG. 5;

FIG. 7 is an exploded sectional view of part of the base plate of FIG. 5 when in position mount to the structure of FIG. 1;

FIG. 8 is a view similar to FIG. 7 showing the base plate mounted to the structure;

FIG. 9 is a bottom perspective view of a fully assembled patio forming ground structure according to a preferred embodiment of the present invention;

FIG. 10 is a sectional view of the ground structure of FIG. 1 with a person walking on the ground structure;

FIG. 11 is an exploded perspective view of the undersurface of a ground structure according to a further preferred embodiment of the present invention;

FIGS. 12 through 14 are top perspective views of edge trim pieces fittable with the ground structure of FIG. 11;

FIG. 15 is a bottom perspective view of the trim piece shown in FIG. 13 of the drawings;

FIG. 16 is a bottom perspective view the trim piece shown in FIG. 12 of the drawings;

FIG. 17 is a sectional view along the lines 17-17 of FIG. 15;

FIG. 18 is a top perspective view of a ground structure when fitted with the edge trim components of FIGS. 12 through 14; and

FIG. 19 is an exploded bottom perspective view of a ground structure according to yet a further preferred embodiment of the present invention.

### DETAILED DESCRIPTION ACCORDING TO THE PREFERRED EMBODIMENTS OF THE PRESENT INVENTION IN WHICH

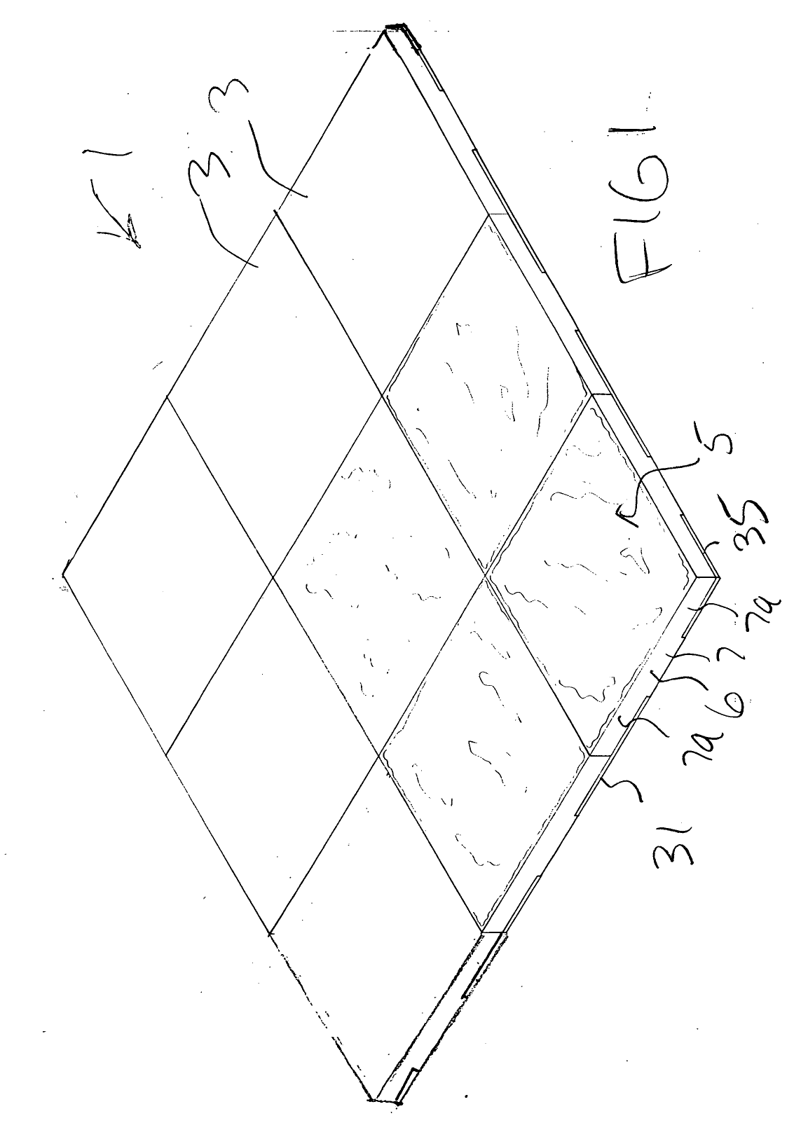

FIG. 1 shows a patio forming ground structure generally indicated at 1. This ground structure is formed by a plurality of replica patio stone members 3. Each of the members 3 has a resin construction preferably formed in a single shot molding operation. The resin material used will be one that has strength to stand up to the intended use and has outdoor weathering characteristics. Such resins are well known to those skilled in the art.

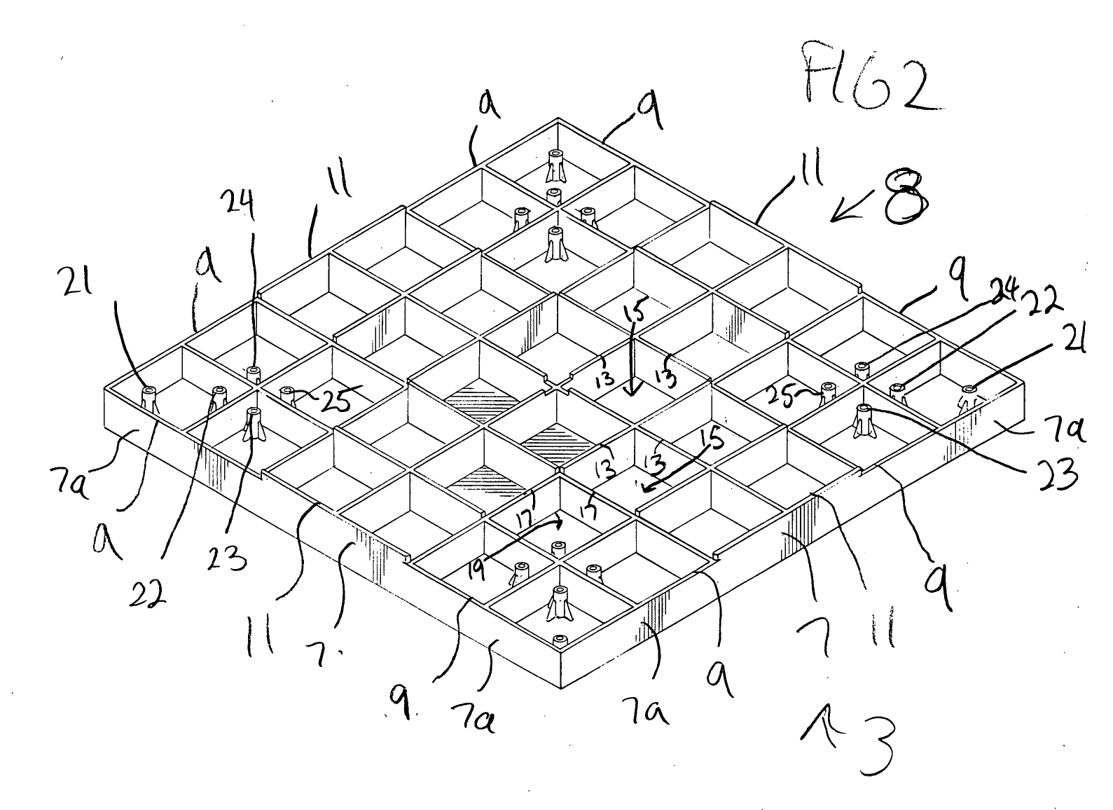

The resin construction of each of the members 3 includes a top wall generally indicated at 5, a downwardly directed sidewall generally indicated at 6 in FIG. 1 and a substantially hollow cellular top wall undersurface generally indicated at 8 as seen in FIG. 2 of the drawings.

The top wall 5 of members 3 may be provided with a decorative look such as a ridged or swirled appearance which in combination with brown, gray etc. coloring of the resin material gives each of the members 3 a genuine stone appearance.

As will be appreciated from FIG. 2 of the drawings even though the replica stone members are of a size consistent with standard patio stones they are only a fraction of the weight. This is because of both the resin material used to make each of the replica stone members and also because of the generally hollow undersurface construction of each of the replica stone members. More particularly, both the top wall and the sidewall are relatively thin. The area surrounded by the sidewall beneath the top wall has, as noted above, a cellular construction formed by relatively thin intersecting vertical walls around large open pockets in the cellular construction. These intersecting walls as best in FIG. 10 of the drawings provide load bearing support beneath the top wall of each of the replica stone members.

FIG. 2 shows many of the different features of replica stone members 3. For example, FIG. 2 shows that the sidewalls 6 of members 3 include sidewall regions 7 and 7a. Sidewall regions 7a include a lower edge 9 which is raised or elevated relative to the lower edge 11 of wall regions 7. FIG. 2 clearly shows that the raised edges 9 are found at each at the four corners of the square shaped replica stone member.

The cellular network interiorly of the sidewall is formed by intersecting vertical walls 13 around pockets 15. It is also formed by intersecting vertical walls 17 around pockets 19. The vertical walls 13 are of a height consistent with wall regions 7 while the vertical walls 17 are of a height consistent with wall regions 7a.

Further provided in each of the undersurface corners of the replica stone member are a plurality of posts indicated at 21, 22, 23, 24 and 25. These posts are formed directly on the underside of the top wall of the replica stone member.

Again, it is to be noted that all of the features described above are preferably all part of a single mold.

Each of the replica stone members 3 is fitted with one or more base plates. In the preferred embodiment and in order to fit the specific configuration shown in FIG. 2 of the drawings each of these base plates has either a square or an elongated rectangular configuration. These base plates will be described later in greater detail.

One of the functions provided by each of the base plates is that it provides a seating surface for the replica stone member. As will be appreciated from what is shown in FIG. 2 of the drawings replica stone members 3 without a base plate would have a tendency to embed or to sink into an outdoor grass surface or the like. Each base plate which fits over a number of the vertical walls and covers a plurality of the open pockets in the cellular undersurface of the replica stone member provides substantially more surface area for seating the replica stone member. This increased seating area substantially eliminates penetration of the undersurface of the replica stone member into a surface such as a grass surface on the like on which it the replica stone member may be placed.

According to another aspect of the invention the base plates beneath the replica stone members act as connectors for connecting the replica stone members together with one another in forming the ground structure. In addition, the base plate may further act as connectors for connecting edge trim pieces to the ground structure.

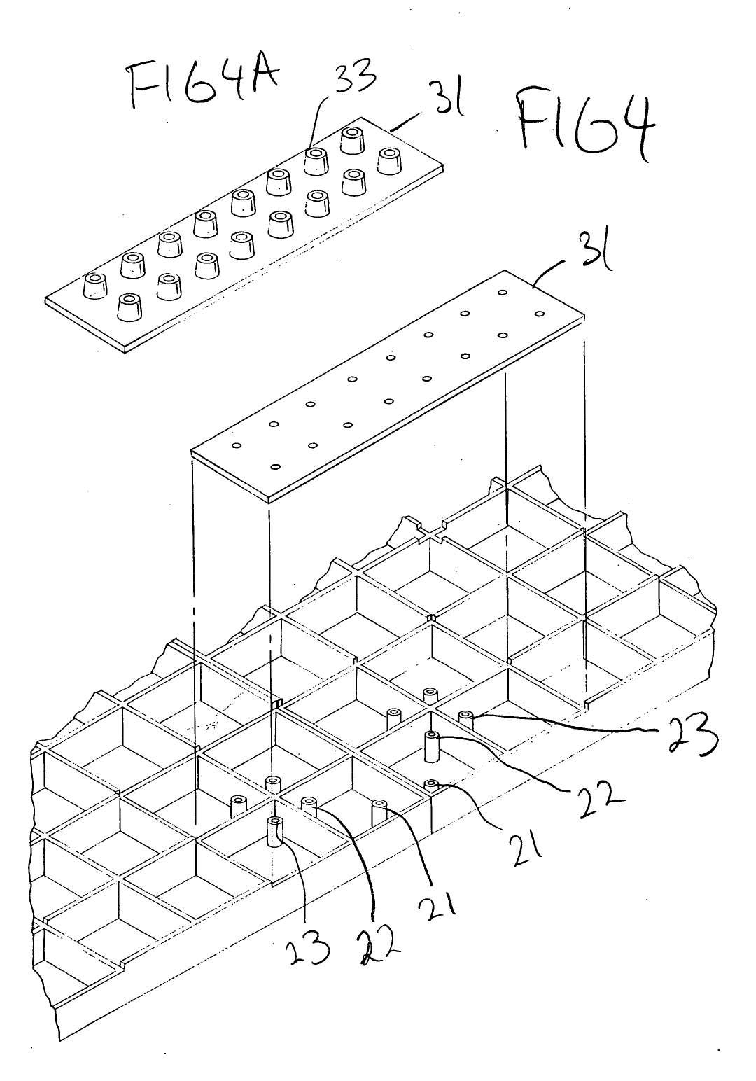

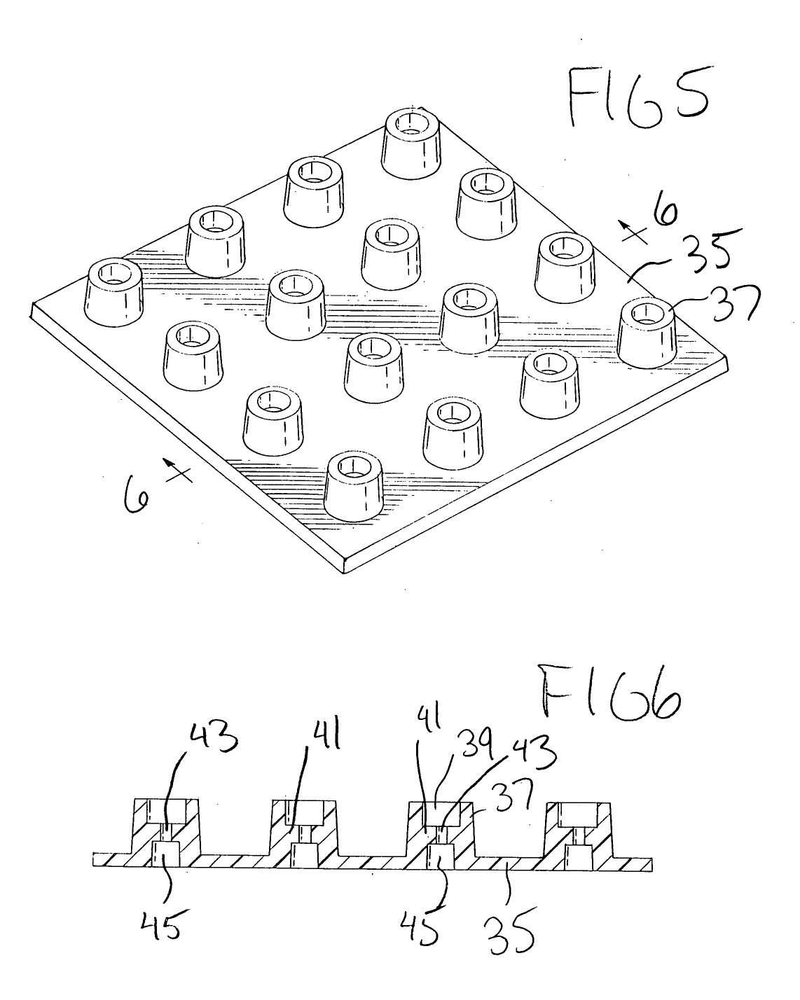

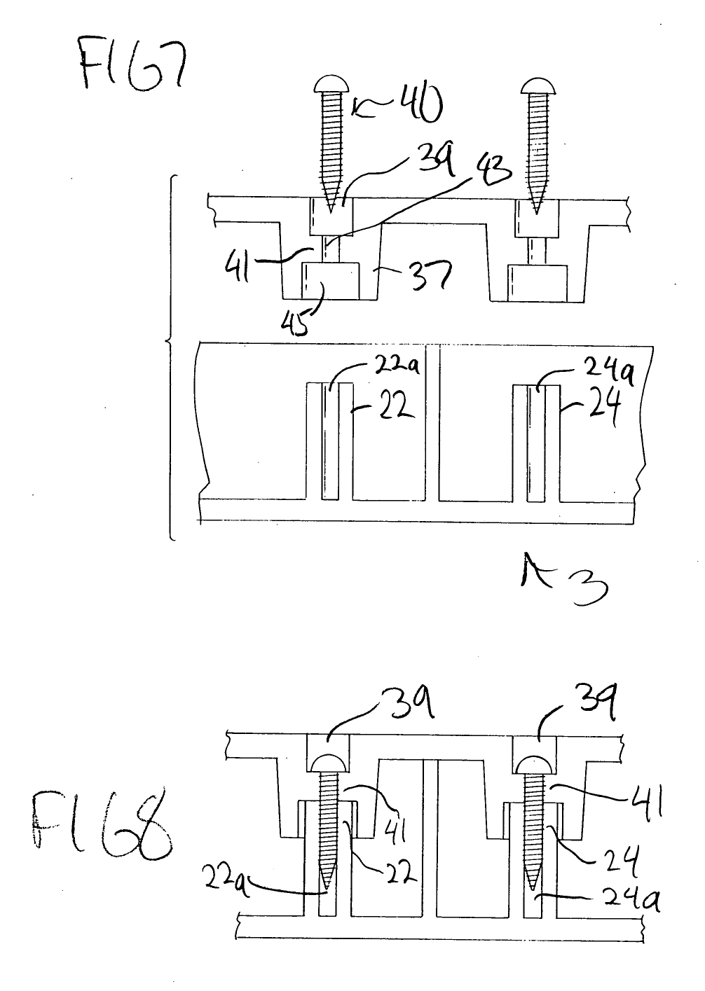

FIGS. 4 and 5 of the drawings show at 31 and 35 respectively the elongated rectangular and the square base plates referred to above. As will be seen, each of the base plates includes a top surface provided with a plurality of upwardly projecting posts 33 on plate 31 and 37 on plate 35. As best seen having reference to FIGS. 7 and 8 of the drawings the posts on the plates are shaped to mate with the downwardly projecting posts on the undersurface of the replica stone member. A whole host of different mating configurations between the posts on the replica stone members and the plates can be used depending upon the purpose of the plate i.e., whether its used strictly as a ground seating surface or whether it is used as both a ground seating and as connector.

Before going into details regarding the different functions of the base plates reference is had to FIGS. 7 and 8 showing how the base plates connect to the replica stone members.

FIG. 7 shows that the posts 22 and 24 on the undersurface of member 3 which are identical to all of the other posts include a central opening 22a and 24a respectively. The post 37 on base plate 35 which is identical to any one of the posts on plate 31 has a front mouth 45 sized to fit over any one of the stone member posts. Located behind mouth 45 is a stop 41 which as can be seen in FIG. 8 locates against the outer end of post 22 and post 24.

An opening 39 through the main body of the plate aligns through a smaller diameter channel 43 with opening 45. Channel 43 is consistent in diameter with the center openings 22a and 24a in the member plates 22 and 24 respectively. Mechanical fasteners 40 screw through the channels 43 of the plate post into the openings in the member posts to secure the plates to the undersurface of the members as seen in FIG. 8 of the drawings.

The above securing operation of the plates to the members is done with the plates in an upside-down position. The members are then turned right side up putting the plates in a base position on the members.

Like each of the replica stone members 3 each of the plates preferably has a molded resin construction. Therefore, even when the plates are fitted with the replica stone members the overall structure does not become overly heavy or awkward to work with.

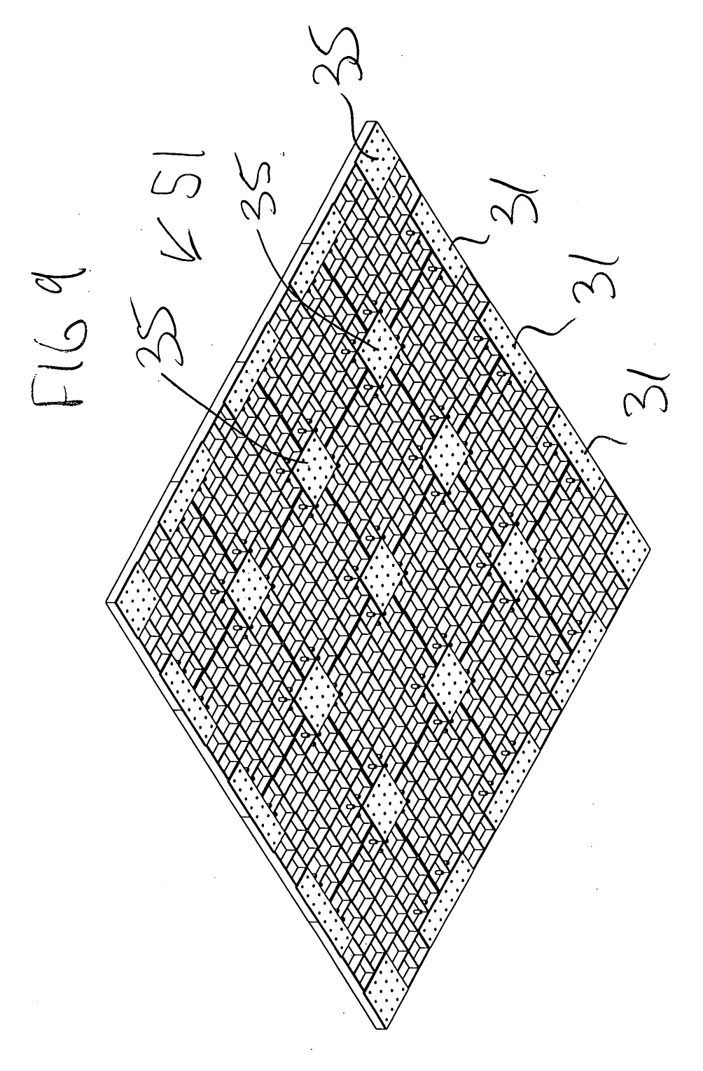

FIG. 9 of the drawings shows a patio forming ground structure generally indicated at 51. This structure is substantially the same as structure 1 with the exception that it is slightly larger than structure 1 i.e., it includes more replica stone members 3. In all other aspects, structure 51 is identical to structure 1. FIG. 9 shows that plate 35 can be used as either an interior connector plate or as an exterior corner finishing plate. FIG. 9 also shows that plates 31 are used as connector plates along the exterior edges of structure 51.

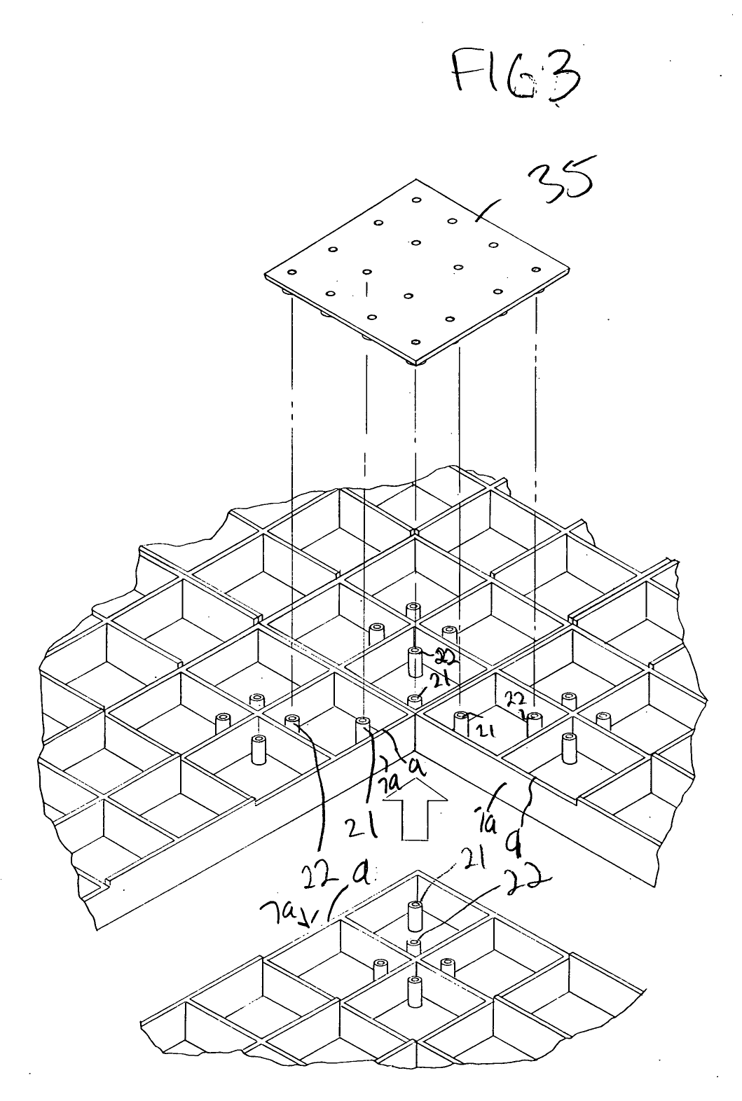

FIG. 3 shows the use of plate 35 as an interior connector plate between adjacent blocks within the structure. In this configuration the posts on plate 35 connect with the posts 21 and 22 where four of the replica stone members meet with one another. The raised edges 9 of the wall regions 7a at the corners of the members 3 allow plate 35 to connect to the undersurface of each of the members and to further project beyond the sidewall of each of the members to form the connection with the adjacent replica stone member.

FIG. 4 of the drawings shows how the posts on plate 31 fit with the posts 21, 22 and 23 of side by side replica stone members along the outside edge and away from the corners of the ground structure. The thickness of the main body of the plate is consistent with the degree to which the edges of the replica stone members are raised. The length of the plate is also consistent with the length of side by side edge regions 7a of two replica stone members. Therefore, when the plate is fitted to the two side by side replica stone members it forms a continuation of the edge regions 11 along the bottom of the structure. As can be seen in FIG. 1 of the drawings this provides a continuous flat bottom surface along the outer edge of the ground structure.

When plate 35 is used strictly as a base plate at the outer corners of the ground structure as seen in FIG. 9 the posts on the plate fit with all five of the member posts 21, 22, 23, 24 and 25. Once again like plate 31 plate 35 at the outside corner of the ground structure fills in the raised edge region to give the corner of the structure a flat or flush bottom surface. This again is well shown in FIG. 1 of the drawings.

FIG. 10 of the drawings shows that the base plates when fitted to structure 1 both sit at ground level and provide connectors between replica stone members. A person standing on a joint between the replica stone members will simply push down on plate 35 (at an interior region of ground structure) or on the plates 31 if the person is walking near the edge of the ground structure. The plates distribute the weight of the person over a relatively large surface area so that, of the surface area is not something as hard as concrete or the like, the ground structure will not be embedded into the surface area. Furthermore, the plates keep the edges of the side by side replica stone members aligned with one another as opposed for example to what can happen with conventional patio stones where because of ground frost and the like one patio stone will upheave relative to an adjacent patio stone. This problem is avoided when working with the unified ground structure of the present invention.

Ground structure 1 is in fact sufficiently integrated by the use of the base connectors that it can be built in one location and carried as a single unit to another location. From a practical standpoint the more important benefit is that the entire ground structure can be built while in the upside down position and then flipped over to its use position with all of the replica stone members staying connected to one another.

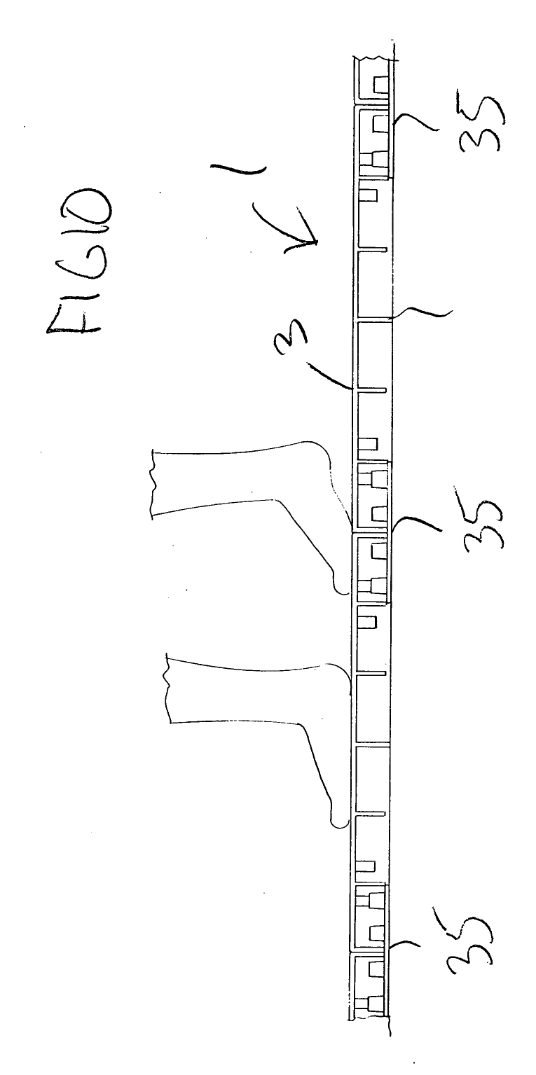

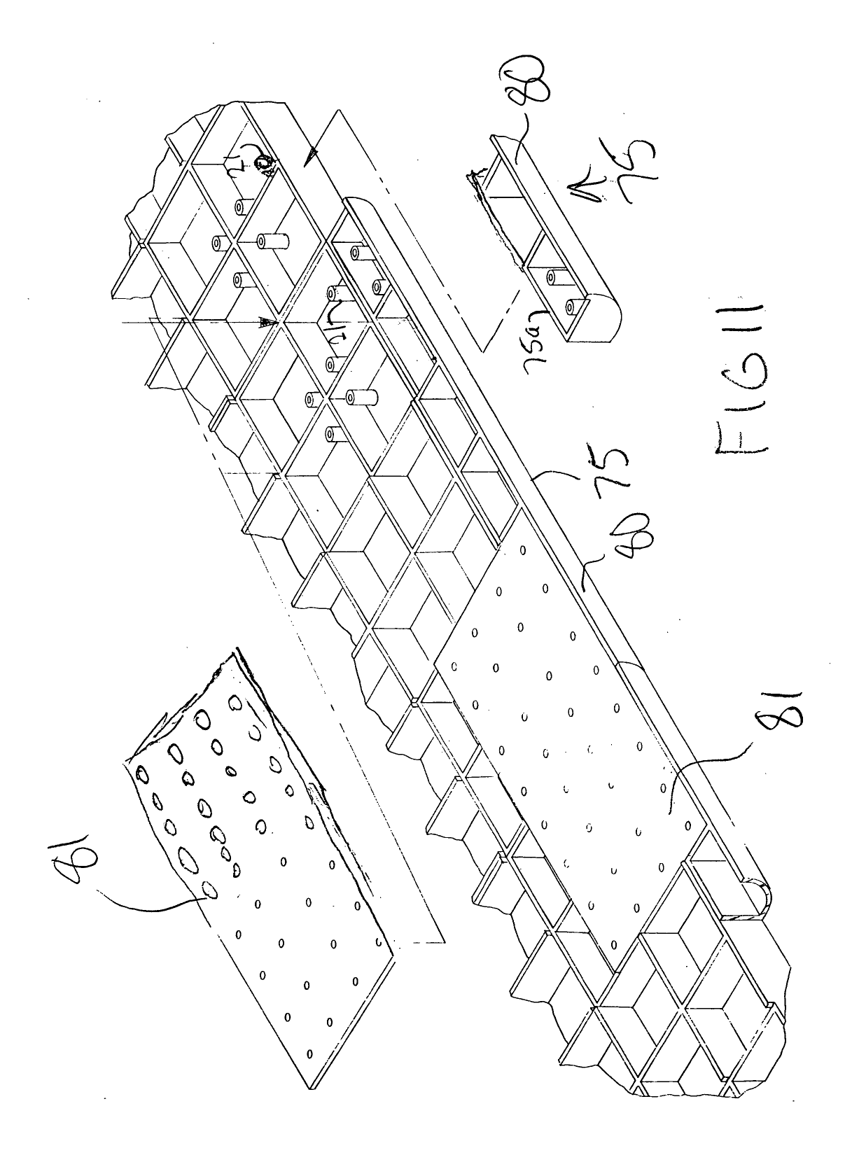

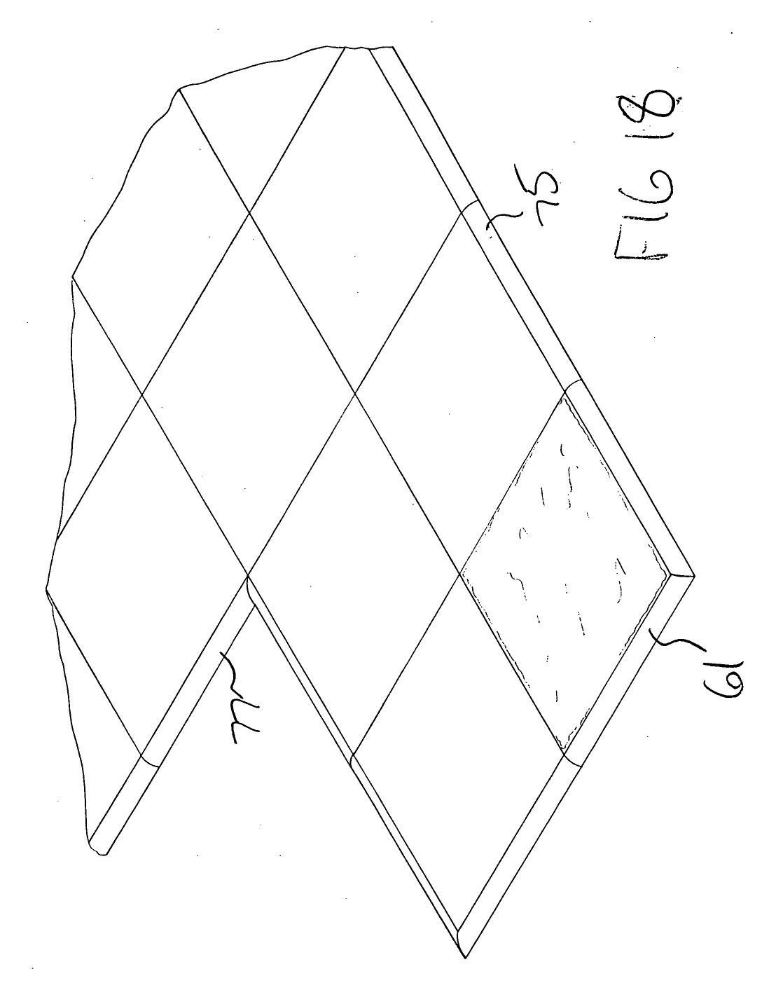

FIGS. 11 through 18 show other preferred features of the invention in which the base plates have further connecting features. More specifically, FIGS. 12 through 17 of the drawings show trim pieces 61, 75 and 77 which can be secured by base plate connectors to the edge of the ground structure.

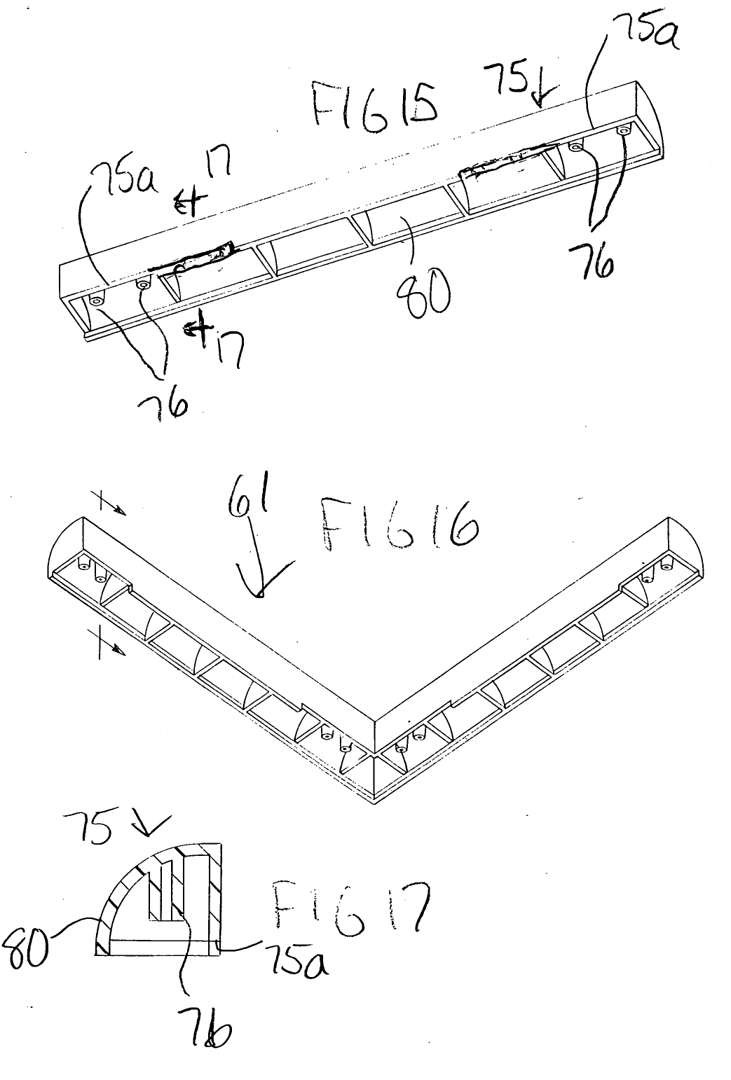

FIG. 11 shows a base plate 81 consistent in width with base plate 35 and twice as long as the bottom corner treatment base plate. Base plate 81 which could easily be replaced by two plates 35 includes base plate posts identical to those earlier described. Plate 81 is positioned such that its outer edge region projects through the raised bottom edges of adjacent replica stone members past the normal edge wall of the ground structure. As such plate 81 presents a line of posts outside of the perimeter of the ground structure to secure a pair of end to end trim pieces 75. These trim pieces as seen in FIG. 15 of the drawings have raised lower edges 75a towards opposite ends of each of the trim pieces 75. Provided interiorly of trim piece 75 also to its opposite ends are a pair of posts 76. Posts 76 are identical to the posts on the base plates.

Base plate 81 projects past the raised edges 75a of the trim pieces such that the posts 76 on the trim pieces then slide over and are mechanically secured to the posts on the base plate. Trim piece 75 includes an outer wall 80 having a lower edge which goes flush to ground level. This gives the structure a finished appearance.

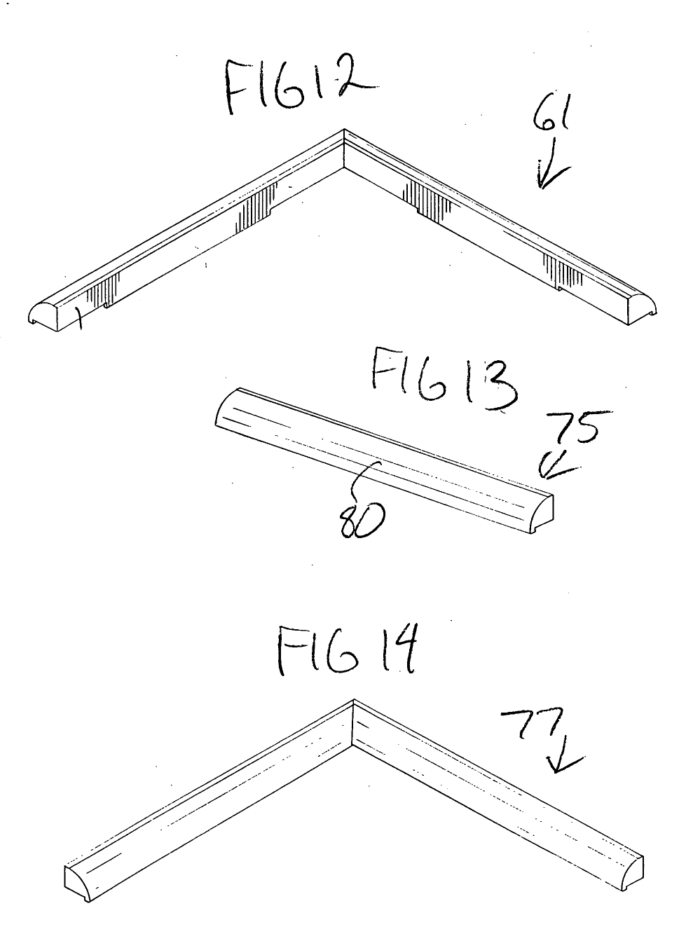

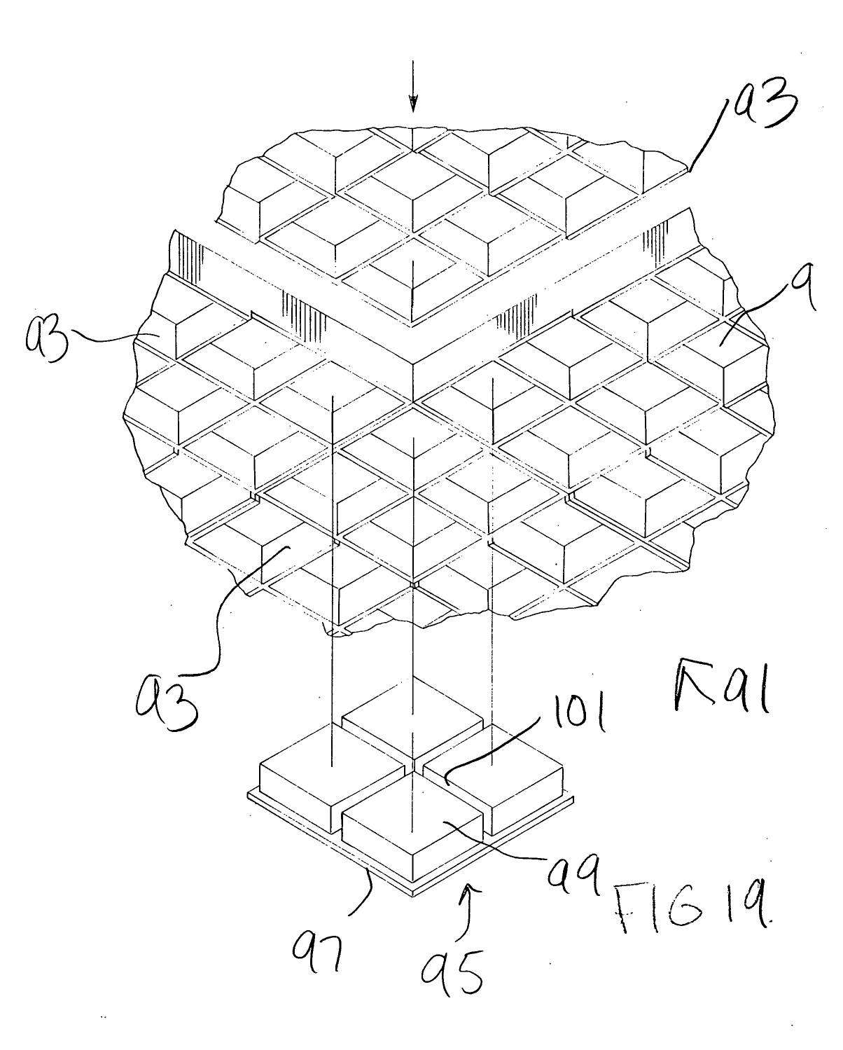

Trim piece 75 as described above extends along a straight edge region of the ground structure. Trim piece 61 of FIG. 12 is used as an outside corner trim piece whereas trim piece 77 shown in FIG. 14 of the drawings is used as an inside edge corner trim piece. The various different positions for trim pieces 61, 75 and 77 are well seen in FIG. 18 of the drawings.

FIG. 19 of the drawings shows that both the undersurface of each replica stone member and the top surface of a base plate can be varied from what has been described above. More specifically, FIG. 19 shows a ground structure generally indicated at 91 formed by a plurality of replica stone members generally indicated at 92. Four of these replica stone members meet edge to edge with one another at an interior region of structure 91. Each of these replica stone members has an open cell undersurface generally indicated at 93. A base plate generally indicated at 95 is used to connect the four replica stone members 92 to one another. Base plate 95 includes a plate portion 97 provided on its upper surface with four rectangular blocks 99 separated from one another by channels 101. Each one of these blocks 99 pushes into the extreme corner pocket on each one of the replica stone members 92. The engagement of the base plate with the replica stone members may be secured strictly by a frictional interlock or it may be additionally secured by some type of mechanical fastener or the like. As the base plate connects the four replica members to one another.

The embodiment of the invention shown in the drawings is specific to a patio formed by replica stone members. This however is not the only modular assembly covered by this invention. By way of example only the invention also pertains to things such as floor tiles and even wall tiles. In all cases each component of the assembly will connect to a base plate that in the preferred construction will secure that component with other components of the assembly.

Although various preferred embodiments of the present invention have been described in detail, it will be appreciated by those skilled in the art that variations may be made without departing from the spirit of the invention or the scope of the appended claims.

1. An assembly of modular components with at least one of said components having a resin construction, said construction including a top wall with a projection downwardly from said top wall, said assembly further including a base plate which secures to said projection and which provides a bottom support for said component.

2. An assembly as claimed in claim 1 wherein said base plate connects said one of said components to another one of said components in said assembly.

3. An assembly as claimed in claim 2 wherein said construction of said one of said components further includes a sidewall extending downwardly around said top wall, said sidewall having a bottom edge with a raised edge region, said base plate extending from beneath said one of said components past said raised edge region to the other one of the components in said assembly.

4. An assembly of modular components including side by side components within said assembly, each of said side by side components having a resin construction, said resin construction of each of said components comprising a top wall of the component, and a projection downwardly from the top wall, said assembly further including a base plate which secures to the projections of the side by side components to connect them to one another.

5. An assembly as claimed in claim 4 wherein said resin construction of each of said components further comprises a sidewall extending downwardly around said top wall, said sidewall having a bottom edge with a raised edge region, said base plate fitting through the raised edge regions of the sidewalls of the side by side components to connect the side by side components with one another.

6. An assembly as claimed in claim 2 wherein said assembly comprises a replacement for a conventional stone patio, said components comprising replica stone members, each replica stone member having said resin construction which further includes a sidewall extending downwardly from said top wall and surrounding a substantially hollow region covered by said top wall, said projection being located in said substantially hollow region.

7. An assembly as claimed in claim 6 wherein said top wall has an undersurface formed with a cellular network comprising a plurality of intersecting vertical walls which provide load support for said top wall and open pockets between said vertical walls.

8. An assembly as claimed in claim 7 wherein said undersurface of said replica stone member and said base plate include male and female interlocks for securing said base plate to said replica stone member.

9. An assembly as claimed in claim 8 wherein said undersurface of said replica stone member includes a plurality of downwardly projecting posts to slideably engage the interlocks of said base plate.

10. An assembly as claimed in claim 9 wherein said replica stone member has a one piece molded construction.

11. An assembly as claimed in claim 9 wherein said posts are dispersed among several of said open pockets of said undersurface.

12. An assembly as claimed in claim 9 wherein said base plate includes a plurality of upwardly projecting posts which are hollow and which slide over said downwardly projecting posts of said undersurface.

13. An assembly as claimed in claim 12 wherein said posts of said base plate include internal stops which locate against said posts of said undersurface, both said internal stops and said posts of said undersurface including screw ports for securing screws to mechanically secure said base plate to said replica stone member.

14. An assembly as claimed in claim 6 wherein said sidewall of said replica stone member has a bottom edge with a raised edge region, said base plate further comprising a connector member for connecting attachments to said assembly, said base plate extending from said undersurface to a position exteriorly of said replica stone member through said raised edge region of sidewall.

15. An assembly as claimed in claim 7 wherein said base plate has a top face which mates with said cellular network, said top face comprising at least one boss which fits into one of the open pockets of the cellular network, said boss being surrounded by recesses to receive the vertical walls around the pocket into which the boss is fitted.

16. An assembly for forming a ground structure as a replacement for a conventional stone patio, said assembly being formed by a plurality of replica stone members all having a resin construction, said construction comprising a top wall having an upper surface and an undersurface, a sidewall extending downwardly around said top wall and surrounding a substantially hollow region beneath said top wall, each replica stone member being fitted with a base member which fits into the hollow region beneath the top wall thereof.

17. An assembly as claimed in claim 16 wherein the base members of the replica stone members comprise connectors which connect the replica stone members to one another in said ground structure.

18. An assembly as claimed in claim 17 wherein the sidewall of each of said replica stone members has at least one raised edge region, the base member of each replica stone member projecting past the sidewall thereof at the raised edge region of the sidewall.

19. An assembly as claimed in claim 18 wherein the base members of the replica stone members form seats for seating the replica stone members on a support surface for the ground structure and also form connectors where said base members project past the sidewalls of the replica stone members.

20. An assembly as claimed in claim 19 wherein the base members connect the replica stone members to one another in said ground structure.

21. An assembly as claimed in claim 19 wherein the base members connect edge accessories to the ground structure.
